(19) United States
(12) Patent Application Publication
(10) Pub. No.: US 2002/0034200 A1
(43) Pub. Date: Mar. 21, 2002

(54) Method of monitoring light from a VCSEL

(76) Inventor: Randy Wickman, Cadott, WI (US)

Correspondence Address: Welsh & Katz, Ltd., Jon P. Christensen, 22nd Floor, 120 South Riverside Plaza, Chicago, IL, 60606, US

(21) Appl. No.: 09/922,335

(22) Filed: Aug. 3, 2001

Related U.S. Application Data
(60) Provisional application No. 60/234,281, filed on Sep. 21, 2000.

(51) Int. Cl. H01S 3/00; H01S 3/13

(52) U.S. Cl. 372/29.02; 372/38.01

(57) ABSTRACT

A method and apparatus are provided for monitoring an output of a solid state laser. The method includes the steps of disposing a photonics detector proximate a light-emitting surface of the solid state laser with an active surface of the photonics detector disposed in a path of and at an obtuse angle to a predominant axis of transmission of the solid state laser and disposing a waveguide proximate the light-emitting surface of the solid state laser and the active surface of the photonics detector, with a predominant axis of transmission of the wave guide aligned to receive light reflected from a plane defined by the active surface of the photonics detector disposed at the obtuse angle to the path of transmission of the solid state laser.

### FIELD OF THE INVENTION

The field of the invention relates to solid state lasers and more particularly to monitoring of an output from a solid state laser.

### BACKGROUND OF THE INVENTION

Solid state lasers are generally known. Such devices are typically constructed by coupling a light-emitting diode to a resonant cavity.

A vertical cavity surface emitting laser (VCSEL) is one type of solid state laser. For example, 850 nm VCSELs may be built in the AlGaAs/GaAs material system and fabricated on a GaAs substrate. Like most semiconductor lasers, the active region of the VCSEL consists of multiple quantum wells, but, unlike edge-emitting lasers, the mirrors are formed during epitaxial growth using distributed Bragg reflectors (DBRs). The GaAs substrate functions to absorb photonic energies greater than the GaAs bandgap.

Most VCSEL devices are designed to emit light out of only one of the distributed Bragg reflector (DBR) facets. As such, associated transmission structures may be coupled directly to those facets.

While VCSEL lasers work well, they are still subject to failure and degradation due to time and temperature. Because of the importance of optical communications, a need exists for a means of monitoring VCSEL devices that is not subject to its own inherent defects.

### SUMMARY

A method and apparatus are provided for monitoring an output of a solid state laser. The method includes the steps of disposing a photonics detector proximate a light-emitting surface of the solid state laser with an active surface of the photonics detector disposed in a path of and at an obtuse angle to a predominant axis of transmission of the solid state laser and disposing a waveguide proximate the light-emitting surface of the solid state laser and the active surface of the photonics detector, with a predominant axis of transmission of the wave guide aligned to receive light reflected from a plane defined by the active surface of the photonics detector disposed at the obtuse angle to the path of transmission of the solid state laser.

### BRIEF DESCRIPTION OF THE DRAWINGS

FIG. 1 depicts a optical communication system in accordance with an illustrated embodiment of the invention;

FIG. 2 depicts a laser transmitter system that may be used by the system of FIG. 1;

FIG. 3 depicts details of the system of FIG. 2; and

FIG. 4 depicts optical signal paths that may exist within the system of FIG. 2.

### DETAILED DESCRIPTION OF A PREFERRED EMBODIMENT

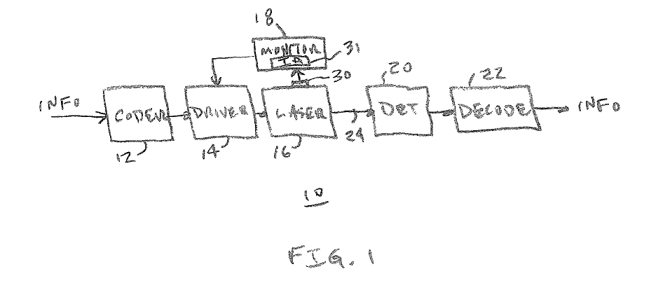

FIG. 1 depicts a simplified laser communication system 10, shown generally under an illustrated embodiment of the invention. Under the illustrated embodiment, an information signal is coded under an appropriate format within a coder 12. An output of the coder 12 may be provided as a control signal to a laser driver 14 that may, in turn, provide a driving signal to the laser 16. The laser 16 may convert the electrical driving signal into an optical signal that may then be transmitted through a waveguide 24 to a remote location.

At the remote location, a detector 20 may convert the optical signal back into the electrical domain. A decoder 22 may retrieve the information signal for use locally.

In order to maintain transmission efficiency across the waveguide 24, a feedback and monitoring circuit 18 may be provided to monitor the output of the laser 16. As an output of the laser 16 changes, the monitoring circuit 18 may detect and adjust a gain of the driving circuit 14, as appropriate to maintain a constant transmission signal.

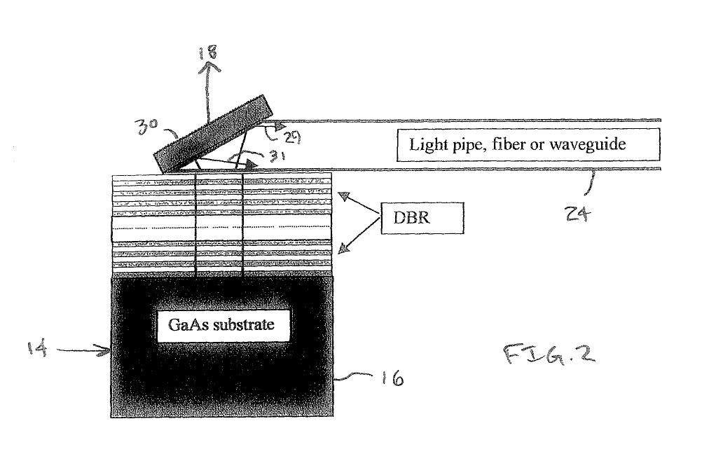

FIG. 2 depicts the laser assembly 16, 30 of FIG. 1. As shown in FIG. 2, a photonics detector 30 (e.g., a PIN photodiode) may be placed at an angle above the laser 16 and used to detect a portion of the output of the laser 16, while reflecting a remaining portion into the waveguide 24.

In order to function as both a detector and reflector, an active surface 38 of the detector 30 may be highly polished. An appropriate coating may be applied to the polished surface to achieve a desired index of refraction.

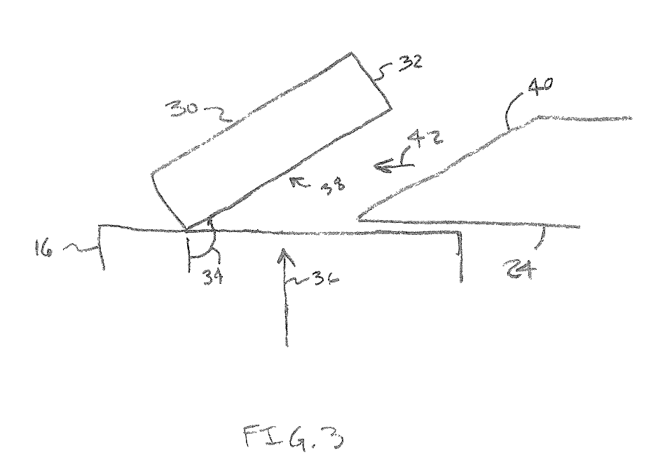

In order to achieve a desired effect, the active surface 38 of the detector 30 may be placed at a predetermined angle (e.g., 45 degrees) with respect to an active surface of the laser 16. Measured from another perspective, the active surface of the detector 30 may assume any appropriate obtuse angle 34 (FIG. 3) between 90 degrees (i.e., perpendicular to a predominant axis of transmission 36 of the laser 16) and 180 degrees (parallel with the predominant axis of transmission 36 of the laser 16.

Further, in order to stabilize the assembly shown in FIG. 2, a tip of the waveguide 24 may be provided with a bevel 40. The bevel 40 may be moved 42 into and substantially occupy the space between the detector 30 and laser 16. The bevel 40 could also be attached to the detector 30, and the two devices could be placed in their appropriate position.

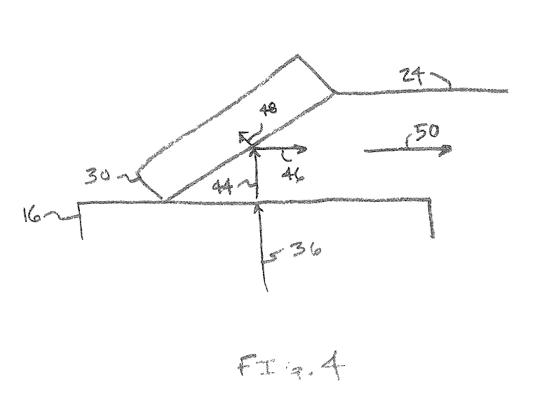

FIG. 4 depicts a set of light paths within the laser assembly 16. As shown, optical energy 44 traveling parallel to the predominant axis 36 of the laser would travel in a straight line through the waveguide 24 until it strikes a discontinuity in the optical interface with the detector 30. At the optical interface with the detector 30, the discontinuity causes a portion 46 of the energy 44 to be reflected parallel to a predominant axis 50 of the waveguide 24. Another portion 48 may be refracted into the detector 30.

While an angle of 45 degrees between opposing surfaces of the laser and detector has been found to be particularly effective, other angles may also be used. For example, it has been found that significant optical energy may be found in paths 29, 31 (FIG. 2) lying at an angle to the predominant axis 36 of the laser 16. Disposing the detector 30 at a angle on either side of 45 degrees allows the detector 30 to capture those energies while still allowing significant energy to reach and be transmitted through the waveguide 24. Further, the waveguide 24 may be aligned to the detector 30 to maximize the energy reflected into the waveguide 24.

Within the detector 30 the portion 48 may be detected and converted into an analog feedback signal. The analog signal, in turn, may be coupled to an inverting amplifier 31 (FIG. 1).

During normal operation, the feedback signal may be used to maintain a laser output appropriate to provide an adequate level of energy impinging upon the detector 20. As the laser 16 ages, the level of the feedback signal may fall. As the level of the feedback signal falls, the inverting amplifier 31 may increase a gain of the driver 14 thereby compensating for loss of laser energy.

A specific embodiment of a method and apparatus for monitoring and controlling a laser transmitter has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of monitoring an output of a solid state laser, such method comprising the steps of:
disposing a photonics detector proximate a light-emitting surface of the solid state laser with an active surface of the photonics detector disposed in a path of and at an obtuse angle to a predominant axis of transmission of the solid state laser; and
disposing a waveguide proximate the light-emitting surface of the solid state laser and the active surface of the photonics detector, with a predominant axis of transmission of the wave guide aligned to receive light reflected from a plane defined by the active surface of the photonics detector disposed at the obtuse angle to the path of transmission of the solid state laser.

2. The method of monitoring an output of a solid state laser as in claim 1 further comprising beveling a tip of the waveguide to conform to the obtuse angle of the photonics detector.

3. The method of monitoring an output of a solid state laser as in claim 1 further comprising disposing the beveled tip of the waveguide substantially between the solid state laser and the active area of the photonics detector.

4. The method of monitoring an output of a solid state laser as in claim 2 further comprising aligning the predominant axis of transmission of the waveguide normal to the predominant axis of transmission of the solid state laser.

5. The method of monitoring an output of a solid state laser as in claim 1 further comprising detecting an output of the solid state laser using the photonics detector.

6. An apparatus for monitoring an output of a solid state laser, such method comprising the steps of:
means disposed in a path of the solid state laser and adapted to detect a first portion of the output of the solid state laser;
means disposed in the path of the solid state laser substantially coincident with the means to detect and adapted to reflect a second portion of the output of the solid state laser into a waveguide; and
the waveguide.

7. The method of monitoring an output of a solid state laser as in claim 6 further comprising aligning a predominant axis of transmission of the waveguide normal to a predominant axis of transmission of the solid state laser.

8. An apparatus for monitoring an output of a solid state laser, such method comprising the steps of:
a photonics detector adapted to be disposed proximate a light-emitting surface of the solid state laser with an active surface of the photonics detector disposed in a path of and at an obtuse angle to a predominant axis of transmission of the solid state laser; and
a waveguide adapted to be disposed proximate the light-emitting surface of the solid state laser and the active surface of the photonics detector, with a predominant axis of transmission of the wave guide aligned to receive light reflected from a plane defined by the active surface of the photonics detector.

9. The apparatus for monitoring the output of a solid state laser as in claim 8 wherein the waveguide further comprises a beveled tip.

10. The apparatus for monitoring the output of a solid state laser as in claim 9 further comprising the beveled tip of the waveguide disposed substantially between the solid state laser and the active area of the photonics detector.

11. The apparatus for monitoring the output of a solid state laser as in claim 8 further comprising the predominant axis of transmission of the waveguide aligned normal to a predominant axis of transmission of the solid state laser.

12. The apparatus for monitoring the output of a solid state laser as in claim 8 wherein the photonics detector further comprises a photodiode.

13. A method of monitoring an output of a solid state laser, such method comprising the steps of:
disposing a photodetector proximate a light-emitting surface of the solid state laser with an active area of the photodetector disposed in a path of and at an obtuse angle to a predominant axis of transmission of the solid state laser; and
disposing a waveguide proximate the light-emitting surface of the solid state laser and the active area of the photodetector, with a predominant axis of transmission of the wave guide aligned to receive light reflected from an optical interface formed with the photodetector disposed at the obtuse angle in the path of transmission of the solid state laser.

14. A method of monitoring an output of a solid state laser, such method comprising the steps of:
disposing a photodetector proximate a light-emitting surface of the solid state laser with an active area of the photodetector disposed in a path of and at an obtuse angle to a predominant axis of transmission of the solid state laser; and
disposing a waveguide proximate the light-emitting surface of the solid state laser and the photodetector, with an axis of transmission of the wave guide aligned to receive light reflected from an optical interface formed with the active area of the photodiode disposed in the path of the solid state laser.
